(19) United States
(12) Patent Application Publication
(10) Pub. No.: US 2020/0366028 A1
(43) Pub. Date: Nov. 19, 2020

(54) POWER INLET FOR HIGH POWER THROUGHPUT BATTERY CHARGING

(71) Applicant: ABB Schweiz AG, Baden (CH)

(72) Inventors: Martin Krucinski, Glastonbury, CT (US); Gregory Cole, West Hartford, CT (US)

(21) Appl. No.: 16/414,366

(22) Filed: May 16, 2019

(51) Int. Cl. H01R 13/639; H01R 13/631; H01R 13/633; H01R 13/453; H01R 13/53; H01R 43/26; B60L 53/16

(52) U.S. Cl. CPC H01R 13/639; H01R 13/631; H01R 13/633; H01R 13/453; B60K 6/22; H01R 43/26; B60L 53/16; H01R 2201/26; H01R 13/53

(57) ABSTRACT

A power inlet and connector interface useful to transfer power between a power source and a vehicle. In one form the vehicle includes a battery, such as a lithium-ion battery, capable of being charged with high powers. In some forms the battery can be charged with 1 MW, 2 MW, 3 MW and higher power transfers. The power inlet can include a door the coves a power receptacle useful to receive the connector, and a translatable carriage useful to define at least part of the power receptacle. In some forms a cover is included. The power receptacle can include a wall having a passage to permit the insertion of power connector pins, the wall moving with movement of the carriage. When the connector is inserted into the power receptacle, insertion of the pins can be made via relative movement of the pins on the vehicle side with passages in the connector.

### TECHNICAL FIELD

The present invention generally relates to power inlets for battery charging, and more particularly, but not exclusively, to vehicle situated power inlets for battery charging.

### BACKGROUND

Providing power inlets having high power throughput capabilities necessitates those same inlets having safety interlock capabilities to protect operators. Some existing systems have various shortcomings relative to certain applications. Accordingly, there remains a need for further contributions in this area of technology.

### SUMMARY

One embodiment of the present invention is a unique power inlet for a vehicle, such as a truck. Other embodiments include apparatuses, systems, devices, hardware, methods, and combinations for providing high power battery charging through a safety interlocked power inlet. Further embodiments, forms, features, aspects, benefits, and advantages of the present application shall become apparent from the description and figures provided herewith.

### BRIEF DESCRIPTION OF THE FIGURES

FIG. 1 depicts an embodiment of a vehicle with a power inlet.

FIG. 2 depicts an embodiment of a vehicle with a power inlet.

FIG. 3 depicts an exploded view of a power inlet and connector.

FIG. 4 depicts a connector inserted into a power inlet.

FIG. 5 depicts an embodiment of a safety interlock.

FIG. 6 depicts an embodiment of a motive member used to engage a connector with electrical pins.

FIG. 7 depicts a view of a power inlet housing and electrical pins.

FIG. 8 depicts a view of a housing having a wall covering electrical pins of the housing.

FIG. 9 depicts a connector inserted into a power inlet.

FIG. 10 depicts a connector inserted into a power inlet.

FIG. 11 depicts a power inlet ready to receive a connector.

FIG. 12 depicts a power inlet having a door open ready to receive a connector.

FIG. 13 depicts a power inlet which has received a connector.

FIG. 14 depicts a power inlet in which the connector has been moved into position to contact the pins.

FIG. 15 depicts a vehicle having a power inlet.

FIG. 16 depicts a vehicle having a power inlet.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

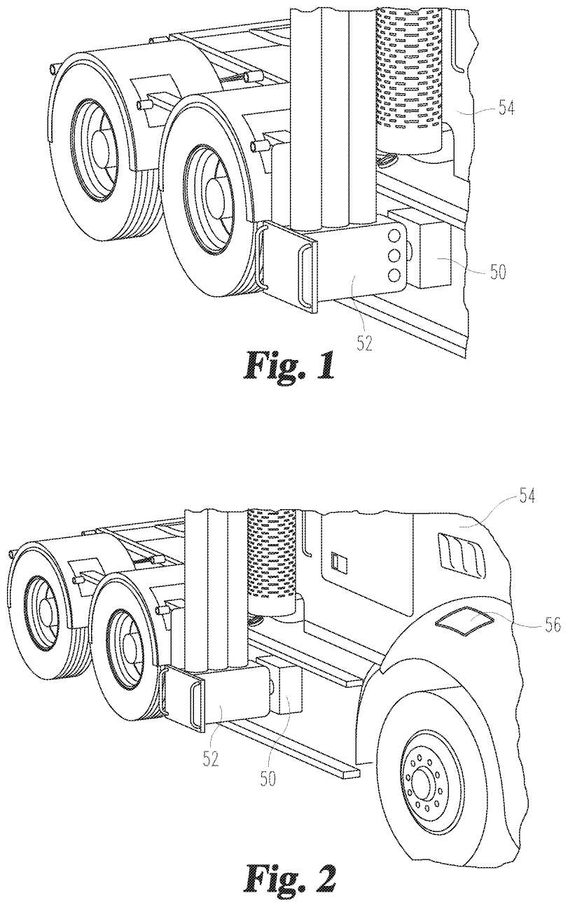

With reference to FIG. 1, a power inlet 50 capable of being connected with a power connector 52 is shown in which the power inlet 50 is used with a vehicle 54. The power inlet 50 is structured to handle high electrical power transfers between the power connector 52 and an energy storage 56. The energy storage 56 can take any variety of forms useful to provide power, either main or auxiliary, to the vehicle 54. In one form the energy storage 56 can take the form of a lithium ion battery and/or battery pack, super capacitor energy storage, etc. It is contemplated that in the embodiments in which the energy storage 56 provide main power to the vehicle 54 that such main power can be used to provide motive power through a drive train to the vehicle 50.

Embodiments disclosed herein can be used on a variety of vehicles, and in some forms can be used on vehicles having capabilities of recharging onboard batteries using connections that provide greater than 1 MW in charging power. In some forms embodiments disclosed herein can be used on recharging connections capable of conveying high power. In some nonlimiting cases this includes recharging connections capable of more than 2 MW, and in some cases more than 3 MW of power. In some non-limiting embodiments the vehicles can be a commercial vehicle and additionally and/or alternatively take the form of medium and/or heavy duty trucks such as but not limited to cement trucks, semi-tractors used in tractor-trailer applications, refrigerator trucks, box vans, off-road trucks, dump trucks, garbage/refuse trucks, etc.

Given the size of charging devices and magnitude of power being transferred, various standard and regulatory bodies may have requirements that are met by the embodiments described herein. The power inlet 50 and connector 52 can be provided with features that meet specifications associated with the Charging Interface Initiative (CharIN) and/or ISO standards and/or CE standards.

As illustrated in FIGS. 1 and 2, the power connector 52 can be coupled to a power source, such as but not limited to a utility grid, via a number of conductors. Shown in FIGS. 1 and 2 are one non-limiting embodiment in which three conductors are used to transfer power between the energy storage 56 and the power source. Such power transfers can be bi-directional (i.e. from the power source to the energy storage 56, and from the energy storage 56 to the power source). Fewer or greater numbers of conductors can also be provided, such as an example in which two main conductors are used, or in which in either embodiment additional conductors in the form of power pilots and/or control pilots.

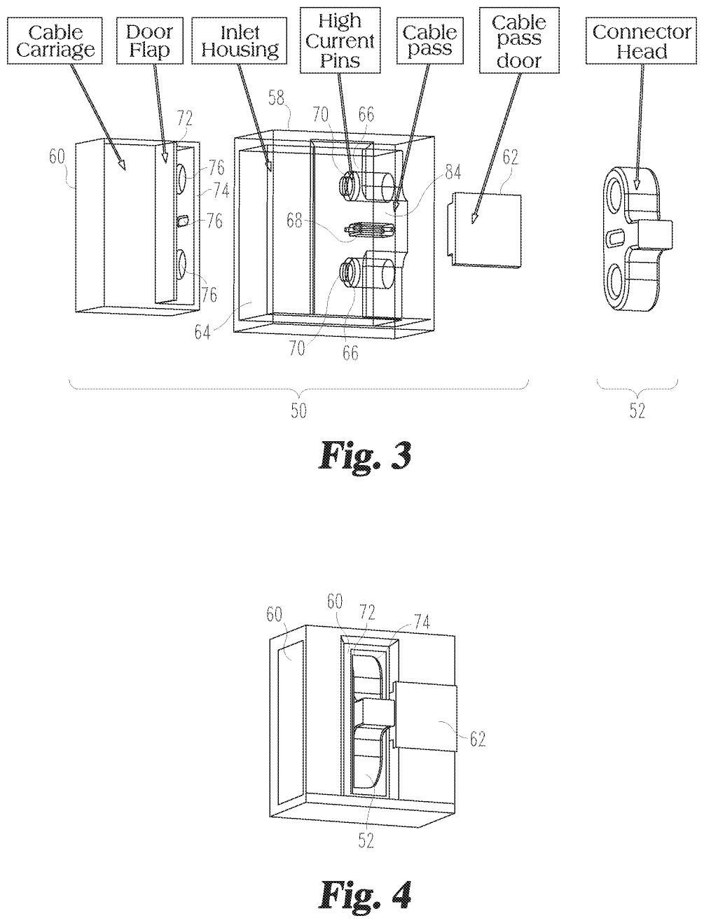

Turning now to FIG. 3, an exploded view of one embodiment of a power inlet 50 and power connector 52 is illustrated. It should be noted that the connector illustrated in FIG. 3 is a different embodiment from the connector 52 illustrated in FIGS. 1 and 2. In the embodiment depicted in FIG. 3 the power inlet 50 includes an inlet housing 58, a carriage 60, and a cable pass door 62. The inlet housing 58 can be statically coupled to the vehicle 54 and includes a passage 64 for receipt of a movable carriage 60 structured to slide back and forth within the passage 64. The inlet housing 58 can include the connector pins 66 which are electrically connected to the energy storage 56. The housing 58 can include a top that is flush with a top surface of the vehicle 54, but not all embodiments need include such flush mounted feature. Also shown in FIG. 3 is an embodiment in which power and control pilots 68 are included. In the illustrated embodiment the pins 66 each include a non-conductive tip 70 which is useful to assist in protecting the conductive pins 66 from inadvertent contact, as will be appreciate given the discussion further below.

The carriage 60 can include a door 72 which assists in protecting a power receptacle into which the connector heat 52 is inserted during the sequence of connection steps necessary to electrically couple the power source to the energy storage 56 via the conductor of the connector pins 66. The door 72 can span the entirety of the space between an edge of the carriage 60 and an opposite side of the space on the inlet housing 58. The door 72 can take the form of a hinged flap (an example of which is shown in the illustrated embodiment), but other forms are also contemplated such as a sliding door, etc. The door 72 is depicted in FIG. 3 as being hinged in an outward direction, but other embodiments contemplate the door 72 being hinged to swing inward toward the power receptacle into which the connector head 52 is inserted.

The carriage 60 includes a wall 74 through which the pins 66 can be extended through upon relative movement of the carriage 60 and inlet housing 58. The pins 66 can take on any variety of shapes and sizes. In one form the pins have a 2″ diameter. Furthermore, the pins 66 can accommodate a variety of voltages and currents. In one form the pins 66 can accommodate 1600 V. Additionally and/or alternatively, in one form the pins 66 can accommodate 5000 amps. The wall 74 can include any number of openings necessary to accommodate the number of pins 66 and/or pilots 68. In some forms the wall 74 is used to permit extension of the pins 66 and/or pilots 68 into the power receptacle formed at least in part by the carriage 60, and to also shield the space in which the pins 66 reside to prevent contamination and possible electrical shorting. Although the carriage 60 is disclosed as having a box like appearance, in some forms the carriage 60 may include an engagement wall into which the connector 52 engages when inserted, as well as the wall 74 which shields the space between the pins 66 when the connector 52 is not installed. Such a form may take any variety of shapes, such as but not limited to a sled which includes a bottom wall to receive an inserted connector 52, as well as the wall 74 which permits insertion of the pins 66 into the power receptacle when the carriage 60 is translated relative to the inlet housing 58. The power receptacle in this embodiment can be defined by the wall 74, a back wall of the sliding sled carriage 60, and an edge of the housing 58. The door 72 in this embodiment may be attached to the housing 58 (either hingedly attached, slidingly attached, etc).

The cable pass door or cover 62 is useful to also shield the space between the pins 66 when the connector head 52 is not inserted into the power receptacle. The cable pass door 62 can be moved to the side during the connection sequence as will be discussed further below. In one form the connector head 52 can include a footprint large enough to extend over the cover 62. Although the cover as illustrated only extends partially along the height of the connector 52, in some forms the cover 62 can take on other dimensions. For example, the cover could extend along the entire height of the connector head 52. Furthermore, in the embodiment depicted in FIGS. 1 and 2, the cover 52 could extend along the entirety of the height of the connector 52.

The connector head 52 can include a passage that extends to both sides of the head 52 as illustrated, but in some forms the connector head may include passages that extend only part of the way into the connector. Such feature can apply to the passage in the head 52 structured to receive the pins 66 and/or the passage in the head 52 structured to receive the pilots 68. The connector head 52 can include a rounded surface as a lead in to the passage that receives the pins 66, so as to provide tolerances and ease the insertion of the pins into the passage. It will be appreciated that the circular features drawn on the connector shown in FIGS. 1 and 2 correspond to the passages useful to receive the electrical pins 66.

FIG. 4 depicts insertion of the power connector 52 into the power receptacle in advance of connection and electrical contact between the power connector 52 and the pins 66. The opening provided in the power receptacle can be sized relative to the power connector 52 such that minimal forces are needed to displace the door 72 and insert the power connector 52.

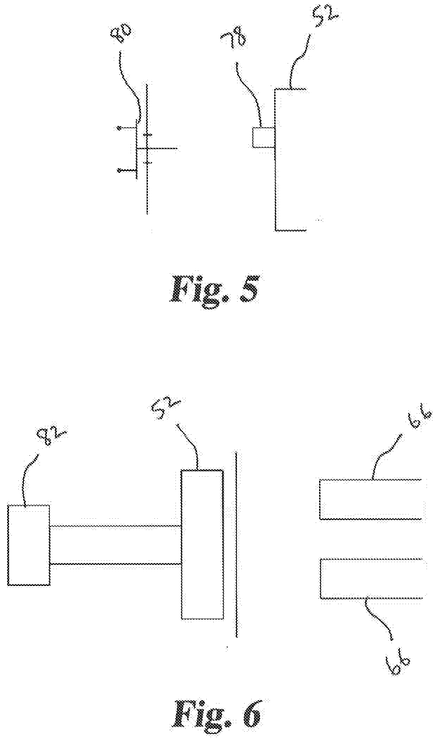

The various embodiments herein can include safety interlock features that prohibit connection between the power connector 52 and pins 66 while the interlock features are engaged. FIG. 5 depicts one example of an interlock scheme in which the connector head 52 can include one or more protrusions 78 which engage with a structure associated with the vehicle 54 and/or inlet housing 58 and/or carriage 60. The protrusions can engage a safety interlock member 80 that may or may not be recessed as shown in FIG. 5. The safety interlock member 80 can be provided through a back wall of the carriage 60, where the protrusion 78 is located on the front of the connector 52 as it is inserted into the power receptacle toward the back wall of the carriage. The member 80 can be located in the vehicle 54 and/or housing 58, but otherwise accessible through an aperture formed in the carriage 60. In other forms the member 80 is located to move with the carriage 60, with other associated interlock members connected with the vehicle 54 and/or housing 58.

The safety interlock member 80 can be interconnected with a locking device that is engaged or disengaged depending on whether the protrusion 78 engages the member 80 and/or sufficiently engages the member 80. In some forms the member 80 must travel a preset minimum distance before disengaging the safety interlock. In some forms the connector 52 may have more than one protrusion or other device suitable to engage one or more safety interlock members. In additional and/or alternative forms the protrusions in a multi-protrusion embodiment can have different lengths, each of which must engage respective safety interlock members 80 a different distance so that the safety interlock is disengaged.

The safety interlock can be a mechanical interlock and/or an electrical interlock. In addition, the safety interlock that is engaged/disengaged by action of the protrusion 78 can take a variety of forms. For example, the safety interlock can be a pin and/or a pin and ball that is engaged/disengaged with action of the protrusion. Such a pin (or any other suitable device) can be directly used to prevent or allow movement of the carriage 60 depending on the state of engagement of the protrusion(s) 78. The safety interlock pin (or other suitable device) can be actuated directly by the member 80, but in some embodiments additional structure such as linkages, cams, rollers, balls, etc may also be interposed between the engagement surface used to receive the protrusion 78 and the physical device useful to lock the carriage 60 from relative movement with the housing 58 and pins 66. The safety interlock can also be used to prevent movement of the cover 62.

The carriage 60 can be moved between a contact and non-contact position with the pins 66 via use of any suitable motive device 82. In one form the motive device 82 can be an actuator, but in other forms the motive device 82 can be a device physically manipulated by a user. The actuator can be actuated from a safe distance, such as from the inside of the vehicle. In some embodiments the motive device 82 can move the connector 52 from an initially seated position (characterized by insertion of the connector 52 into the power receptacle but no electrical contact is made between the connector 52 and pins 66), to an intermediate locked position in which the connector 52 is prevented from being removed from the power receptacle (characterized by no electrical contact between the connector 52 and pins 66), to a final contact position in which electrical contact is made between the connector 52 and pins 66. In some embodiments a user can move the connector 52 from the seated position to the locked position, with a requirement that an actuator complete the connection from the locked position to the contact position. In other forms an actuator may be used to move from the seated to the locked to the contact position. The locked position can be characterized by interference between the connector head 52 and the inlet housing 58, but other locking mechanisms are also contemplated. The safety interlock can be arranged such that power (electrical or otherwise) is not provided to the actuator unless the safety interlock has been disengaged by action of the connector 52 relative to the power receptacle.

In some embodiments an ejector 84 can be used to assist in pushing the connector 52 off of the pins 66 and/or out of the power receptacle. The ejector 84 can take any variety of forms useful to decouple the connector 52 from the pins 66. In one form the ejector is a pin that is actuated. In still other forms, the motive device 82 can be used to pull the connector 52 away from the pins 66.

In those forms in which an actuator can be used to translate the carriage 60 so that the connector 52 makes contact with the pins, a controller can be used to orchestrate the various movements and/or stages. The controller can be comprised of digital circuitry, analog circuitry, or a hybrid combination of both of these types. Also, the controller can be programmable, an integrated state machine, or a hybrid combination thereof. The controller can include one or more Arithmetic Logic Units (ALUs), Central Processing Units (CPUs), memories, limiters, conditioners, filters, format converters, or the like which are not shown to preserve clarity. In one form, the controller is of a programmable variety that executes algorithms and processes data in accordance with operating logic that is defined by programming instructions (such as software or firmware). Alternatively or additionally, operating logic for the controller can be at least partially defined by hardwired logic or other hardware.

The controller can be initiated from a safe distance away from the connector 52 connection point. In addition to controlling the actuator 82, the controller can also be used to control the cover 62 which can be actuated by a separate system than the motive device 82. In addition to controlling the actuator 82, the controller can also be used to monitor system performance. For example, the controller can be used to monitor motor currents in an electric or electromechanical actuator. High motor currents may be indicative of debris and/or contamination, and as such the controller can also be used to flag a potential maintenance activity to clean the pins 66. As will be appreciated, remote activation can provide automated coupling and decoupling sequences with minimal human involvement.

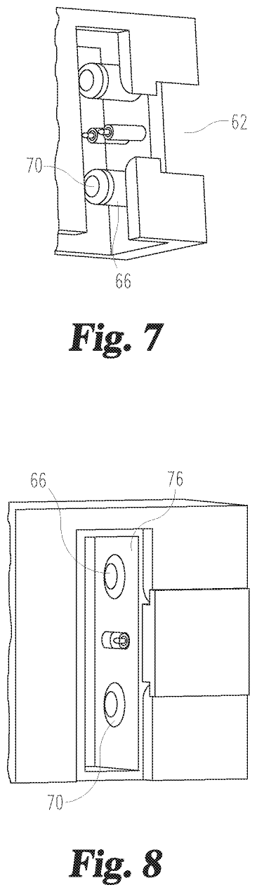

Turning now to FIG. 7, another view of the housing 58 is provided where the carriage 60 and wall 74 have been removed. The pins 66 having the tips 70 are shown. The tips 70 can be affixed via mechanical techniques (e.g. screwing, crimping, etc) and/or via chemical bonding (e.g. adhesive). The pilots 68 are also shown in the illustrated embodiment of FIG. 7. In one form the pilots 68 make contact with a complementary conductor in the connector head 52, and are arranged such that the pilots make contact after the head 52 makes electrical contact with the pins 66. Such a sequence of events ensures that power is provided from the power source to the batter only after sufficient contact has been made between the head 52 and the pins 66. It also ensures that power is interrupted from the power supply to the connector head 52 prior to withdrawal of the pins 66 from the connector head 52 to reduce the risk from arcing. The cover 62 has been displaced slightly to the right as shown in the figure.

FIG. 8 depicts a view of the power receptacle with the carriage 60 and wall 76 inserted to protect the space between the pins 66. As can be seen, the wall 76 is used to shelter the space between the contacts 66 when the carriage 60 is in the position to receive the connector head 52. As will be appreciated in the illustration of FIGS. 7 and 8, the tips 70 are slightly rounded which can aid in insertion into the connector head 52. The tips 70 can have non-rounded shapes, but in many embodiments the axial end of the tip will be smaller than the end to which is attached to the conductor part of pins 66. In some forms the tips 70 can also have a slightly larger diameter than the diameter of the conductor part of the pins 66. Such larger diameter permits the tips 70 to clear the passage of debris/contaminates.

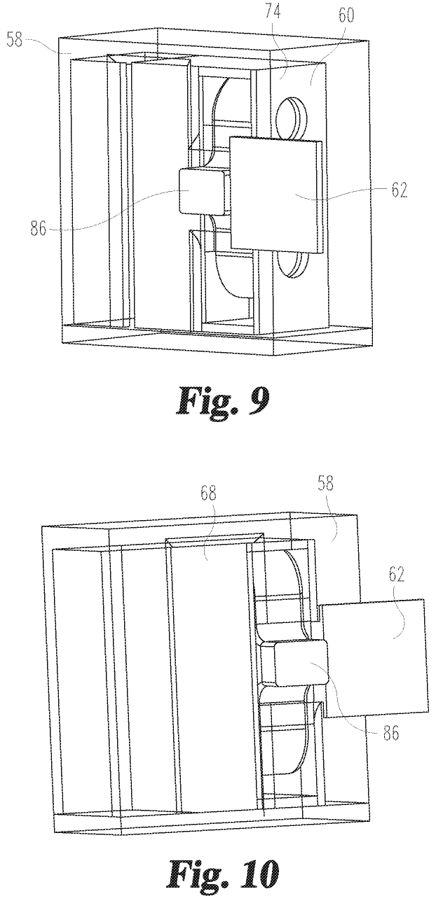

FIGS. 9 and 10 illustrate insertion of the connector head 52 into the power receptacle within the housing 58 and carriage 60, and in which the connector 52 has been moved into conductive contact position with the pins 66 (not shown for clarity). The cover 62 is moved to the side to permit lateral insertion of the connector head 52. As will be appreciated, the connector head 52 is connected to a conductive lead element 86 which is shown partially extending away from the head 52 (the remainder of the lead element 86 is not shown for simplicity of view). Since the lead element 86 extends away from the head 52, space is needed to receive the lead element 86 by moving the cover 62.

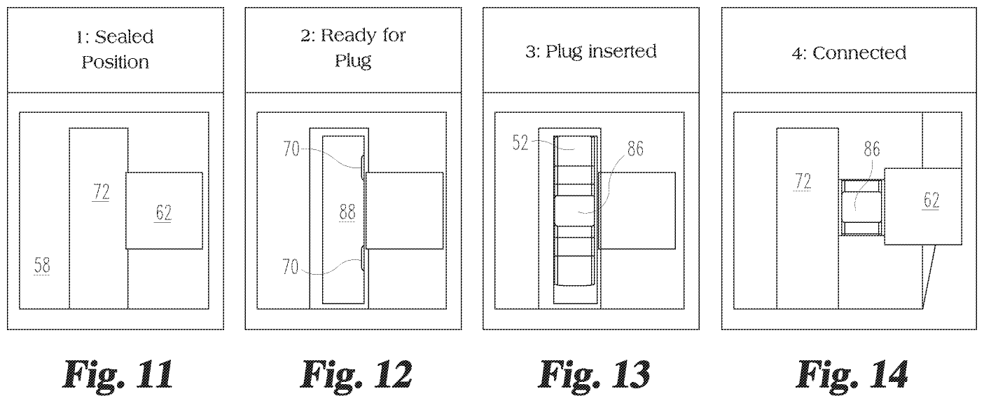

FIGS. 11-14 illustrate various stages of connection between the head 52 and the pins 66. FIG. 11 illustrates a sealed state in which the door 72 and cover 62 are in an initial position before insertion and translation of the head 52. FIG. 12 illustrates the door 72 being moved to an open position in which the power receptacle 88 is exposed and ready to receive the head 52. In some forms the power receptacle 88 can be tapered to crowd the connector 52 into place. Also visible in FIG. 12 is the tips 70. Some embodiments may not include the tips 70 in which case nothing will be visible. The ends of the conductive part of pins 66 can extend just short of the wall 74, or may be offset some distance from the wall 74 back inside the protective space provided by the wall 74 and housing 58. FIG. 13 illustrates insertion of the plug head 52 into the power receptacle 88. FIG. 14 illustrates movement of the plug head 52 toward the pins 66 (not shown) in which position the cover 62 is moved to the side. In the position shown in FIG. 13, the door 72 is permitted to close.

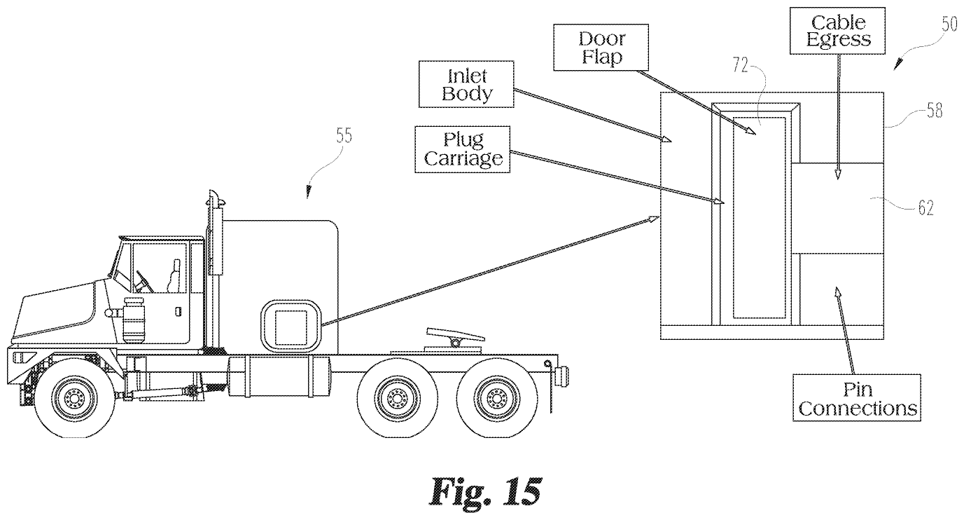

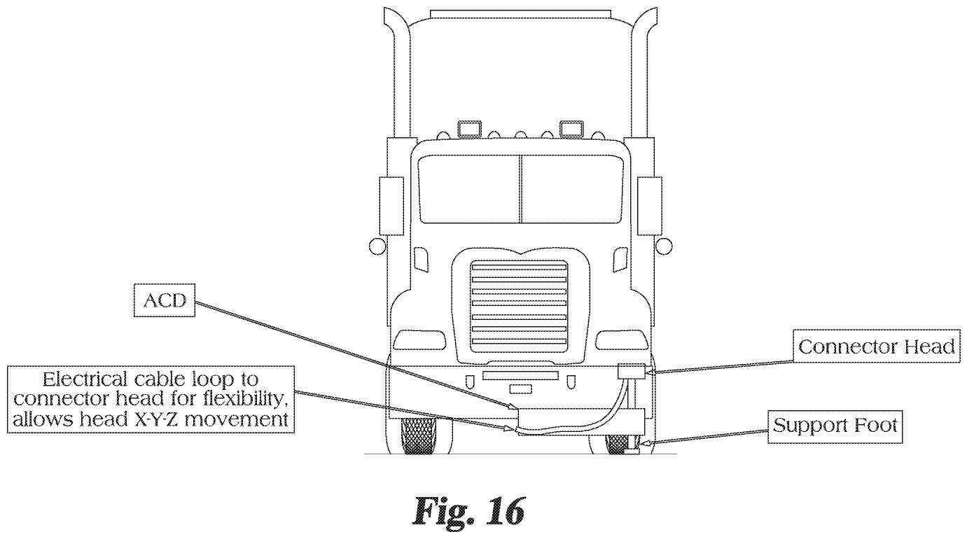

FIG. 15 illustrates an embodiment of the inlet 50 positioned near the rear of the tractor 52. The inlet 50 is in a position ready to receive the connector 52. Though the inlet 50 is illustrated as being structured to receive a connector 52 laterally from the side, it will be appreciated that the inlet 50 can be positioned such that the connector can be inserted from the bottom. Such a feature can be seen in FIG. 16.

One form of the present application includes an apparatus comprising a vehicle power inlet structured to couple a power connector to an electric battery of a car, the vehicle power inlet having: a power receptacle seat structured to receive the power connector, the power receptacle seat having a wall with a plurality of through passages structured to permit passage of a plurality of pins in electrical communication with the electric battery when the wall is moved relative to the plurality of pins, a door positioned to cover the power receptacle seat and structured to be displaced when a power connector is inserted into the power receptacle seat, the door having a closed position to enclose the power receptacle seat and an open position to permit insertion of the power connector into the power receptacle seat, a motive member structured to convey the power connector toward the plurality of pins when the power connector is inserted into the power receptacle seat such that relative movement occurs between the plurality of pins and the wall, and wherein a safety interlock is engaged to permit relative movement of the wall with the plurality of pins via action of the motive member when the power connector is seated into an engagement position within the power receptacle

A feature of the present application provides wherein the power connector includes a plurality of recesses structured to respectively receive the plurality of pins

Another feature of the present application additionally and/or alternatively provides wherein the engagement position is one in which the power connector is in communication with the power receptacle

Another feature of the present application additionally and/or alternatively further includes a disengagement position in which the power connector is not in communication with the power receptacle.

Another feature of the present application additionally and/or alternatively provides wherein the engagement position is one in which the power connector mechanically communicates with a safety interlock associated with the power receptacle.

Another feature of the present application additionally and/or alternatively provides wherein the power connector disengages a safety interlock when in the engagement position, the safety interlock discouraging relative movement of the plurality of pins to the wall when the safety interlock is engaged, and wherein the safety interlock permits relative movement of the plurality of pins to the wall when the safety interlock is disengaged.

Another feature of the present application additionally and/or alternatively provides wherein the motive member is an actuator, and wherein the safety interlock also includes an electrical interlock with the actuator such that the actuator is incapable of moving the power connector toward the plurality of pins when the safety interlock is engaged.

Another feature of the present application additionally and/or alternatively provides wherein the power connector includes at least one protrusion that mechanically couples with a safety interlock associated with the power receptacle.

Another feature of the present application additionally and/or alternatively provides wherein the power receptacle is defined by a carriage.

Another feature of the present application additionally and/or alternatively provides wherein the engagement position is defined by mechanical coupling of the power connector with a back wall of the carriage.

Another feature of the present application additionally and/or alternatively provides wherein the power connector includes at least two protrusions, a first of which has a first length, a second of which has a second length, and wherein the first length is longer than the second length, the at least two protrusions structured to couple with the safety interlock.

Another feature of the present application additionally and/or alternatively provides wherein the motive member is coupled with the carriage, and wherein the carriage is structured to move in response to the motive member to permit engagement of the power connector to the plurality of pins to permit transfer of electrical current therethrough.

Another feature of the present application additionally and/or alternatively provides wherein the motive member is connected to the carriage through a mechanical arm.

Another feature of the present application additionally and/or alternatively provides wherein the motive member is an actuator.

Another feature of the present application additionally and/or alternatively provides wherein the motive member is a hand-operated mechanism.

Another feature of the present application additionally and/or alternatively provides wherein the carriage includes the wall.

Another feature of the present application additionally and/or alternatively provides which further includes a cover that is displaced with movement of the wall.

Another feature of the present application additionally and/or alternatively provides wherein the cover is decoupled from wall and can be moved without movement of the wall relative to the plurality of pins.

Another feature of the present application additionally and/or alternatively provides wherein the cover includes a periphery that encloses each of the plurality of pins.

Another feature of the present application additionally and/or alternatively provides wherein the cover is released from a locked state when the power connector is in the engagement position within the power receptacle to disengage the safety interlock.

Another feature of the present application additionally and/or alternatively provides wherein the carriage translates in a direction along a length of at least one of the plurality of pins.

Another feature of the present application additionally and/or alternatively provides wherein the door is hingedly connected to the carriage.

Another feature of the present application additionally and/or alternatively provides wherein the door is slidingly coupled to the carriage.

Another feature of the present application additionally and/or alternatively provides further includes a divider that shields the plurality of through passages within the power receptacle when the power connector is in a disengagement position with the power receptacle, and wherein the divider is removed from the plurality of through passages when the power connector is in the disengagement position.

Another feature of the present application additionally and/or alternatively provides wherein the divider is actuated to shield the plurality of through passages or be removed relative to the plurality of through passages by action of the engagement and disengagement of the safety interlock, respectively, the divider positioned to shield when the safety interlock is engaged and actuated to be removed relative to the plurality of through passages when the safety interlock is disengaged.

Another feature of the present application additionally and/or alternatively provides wherein the power connector includes an extension that at least partially overlaps the cover such that the extension moves with the cover when the power connector is coupled with the plurality of pins.

Another feature of the present application additionally and/or alternatively further includes a vehicle having the vehicle power inlet.

Another feature of the present application additionally and/or alternatively provides wherein the vehicle is a tractor truck.

Another feature of the present application additionally and/or alternatively provides wherein the power inlet is structured to facilitate power transfers between a batter electrically connected to the plurality of pins and the power connector, the power inlet structured to facilitate transfer of at least 1 MW of electrical power.

Another feature of the present application additionally and/or alternatively provides wherein the battery is a lithium ion battery.

Another feature of the present application additionally and/or alternatively provides wherein each of the plurality of pins is at least 2″ in diameter.

Another feature of the present application additionally and/or alternatively provides wherein the power connector includes a first position in the power receptacle corresponding to a seated position characterized in which the power connector is not in electrical contact with the plurality of pins, a second position in the power receptacle corresponding to a locked position characterized in which the power connector is not in electrical contact with the plurality of pins and in which the power connector is discouraged from removal from the power receptacle, and a third position in the power receptacle corresponding to a contact position characterized in which the power connector is in electrical contact with the plurality of pins.

Another feature of the present application additionally and/or alternatively provides wherein a person is capable of providing power to move the power connector from the seated position to the locked position.

Another feature of the present application additionally and/or alternatively provides wherein the motive member is powered by an actuator, and wherein the motive member in the form of an actuator is required to move the power connector from the locked position to the contact position.

Another feature of the present application additionally and/or alternatively provides wherein the actuator is actuated from a button positioned at a location removed from the plurality of pins such that personnel are protected.

Another feature of the present application additionally and/or alternatively provides wherein personnel protections are governed by applicable regulations and/or standards.

Another feature of the present application additionally and/or alternatively provides wherein the wall is offset from conductive ends of the plurality of pins when the power connector is in an initial insert position.

Another feature of the present application additionally and/or alternatively provides wherein each of the plurality of pins includes an insulated cover over the tips of each of the respective pins.

Another feature of the present application additionally and/or alternatively provides wherein the covers protrude at least partially into each of the respective plurality of through passages when the power connector is not located within the power receptacle.

Another aspect of the present application provides an apparatus comprising: an electric vehicle having a power inlet structured to receive a power connector, the power inlet including a carriage having a power receptacle enclosed by a moveable door having an open and a closed position, the carriage also including a wall with at least one opening to permit passage of an electrical pin when the wall is moved relative to the at least one electrical pin, the power connector structured to move with the wall such that the power connector makes electrical contact with the at least one electrical pin when the wall moves to an engaged position, the carriage and wall being interlocked such that the carriage and wall are discouraged from movement and thus the power connector is discouraged from making electrical contact with the at least one electrical pin unless the power connector engages a safety interlock disengagement associated with the carriage.

A feature of the present application provides wherein the power connector includes a plurality of recesses structured to respectively receive the plurality of pins.

Another feature of the present application additionally and/or alternatively provides wherein the engagement position is one in which the power connector is in communication with the power receptacle.

Another feature of the present application additionally and/or alternatively further includes a disengagement position in which the power connector is not in communication with the power receptacle.

Another feature of the present application additionally and/or alternatively provides wherein the engagement position is one in which the power connector mechanically communicates with a safety interlock associated with the power receptacle.

Another feature of the present application additionally and/or alternatively provides wherein the power connector disengages a safety interlock when in the engagement position, the safety interlock discouraging relative movement of the plurality of pins to the wall when the safety interlock is engaged, and wherein the safety interlock permits relative movement of the plurality of pins to the wall when the safety interlock is disengaged.

Another feature of the present application additionally and/or alternatively provides wherein the motive member is an actuator, and wherein the safety interlock also includes an electrical interlock with the actuator such that the actuator is incapable of moving the power connector toward the plurality of pins when the safety interlock is engaged.

Another feature of the present application additionally and/or alternatively provides wherein the power connector includes at least one protrusion that mechanically couples with a safety interlock associated with the power receptacle.

Another feature of the present application additionally and/or alternatively provides wherein the power receptacle is defined by a carriage.

Another feature of the present application additionally and/or alternatively provides wherein the engagement position is defined by mechanical coupling of the power connector with a back wall of the carriage.

Another feature of the present application additionally and/or alternatively provides wherein the power connector includes at least two protrusions, a first of which has a first length, a second of which has a second length, and wherein the first length is longer than the second length, the at least two protrusions structured to couple with the safety interlock.

Another feature of the present application additionally and/or alternatively provides wherein the motive member is coupled with the carriage, and wherein the carriage is structured to move in response to the motive member to permit engagement of the power connector to the plurality of pins to permit transfer of electrical current therethrough.

Another feature of the present application additionally and/or alternatively provides wherein the motive member is connected to the carriage through a mechanical arm.

Another feature of the present application additionally and/or alternatively provides wherein the motive member is an actuator.

Another feature of the present application additionally and/or alternatively provides wherein the motive member is a hand-operated mechanism.

Another feature of the present application additionally and/or alternatively provides wherein the carriage includes the wall.

Another feature of the present application additionally and/or alternatively provides which further includes a cover that is displaced with movement of the wall.

Another feature of the present application additionally and/or alternatively provides wherein the cover is decoupled from wall and can be moved without movement of the wall relative to the plurality of pins.

Another feature of the present application additionally and/or alternatively provides wherein the cover includes a periphery that encloses each of the plurality of pins.

Another feature of the present application additionally and/or alternatively provides wherein the cover is released from a locked state when the power connector is in the engagement position within the power receptacle to disengage the safety interlock.

Another feature of the present application additionally and/or alternatively provides wherein the carriage translates in a direction along a length of at least one of the plurality of pins.

Another feature of the present application additionally and/or alternatively provides wherein the door is hingedly connected to the carriage.

Another feature of the present application additionally and/or alternatively provides wherein the door is slidingly coupled to the carriage.

Another feature of the present application additionally and/or alternatively provides further includes a divider that shields the plurality of through passages within the power receptacle when the power connector is in a disengagement position with the power receptacle, and wherein the divider is removed from the plurality of through passages when the power connector is in the disengagement position.

Another feature of the present application additionally and/or alternatively provides wherein the divider is actuated to shield the plurality of through passages or be removed relative to the plurality of through passages by action of the engagement and disengagement of the safety interlock, respectively, the divider positioned to shield when the safety interlock is engaged and actuated to be removed relative to the plurality of through passages when the safety interlock is disengaged.

Another feature of the present application additionally and/or alternatively provides wherein the power connector includes an extension that at least partially overlaps the cover such that the extension moves with the cover when the power connector is coupled with the plurality of pins.

Another feature of the present application additionally and/or alternatively further includes a vehicle having the vehicle power inlet.

Another feature of the present application additionally and/or alternatively provides wherein the vehicle is a tractor truck.

Another feature of the present application additionally and/or alternatively provides wherein the power inlet is structured to facilitate power transfers between a batter electrically connected to the plurality of pins and the power connector, the power inlet structured to facilitate transfer of at least 1 MW of electrical power.

Another feature of the present application additionally and/or alternatively provides wherein the battery is a lithium ion battery.

Another feature of the present application additionally and/or alternatively provides wherein each of the plurality of pins is at least 2″ in diameter.

Another feature of the present application additionally and/or alternatively provides wherein the power connector includes a first position in the power receptacle corresponding to a seated position characterized in which the power connector is not in electrical contact with the plurality of pins, a second position in the power receptacle corresponding to a locked position characterized in which the power connector is not in electrical contact with the plurality of pins and in which the power connector is discouraged from removal from the power receptacle, and a third position in the power receptacle corresponding to a contact position characterized in which the power connector is in electrical contact with the plurality of pins.

Another feature of the present application additionally and/or alternatively provides wherein a person is capable of providing power to move the power connector from the seated position to the locked position.

Another feature of the present application additionally and/or alternatively provides wherein the motive member is powered by an actuator, and wherein the motive member in the form of an actuator is required to move the power connector from the locked position to the contact position.

Another feature of the present application additionally and/or alternatively provides wherein the actuator is actuated from a button positioned at a location removed from the plurality of pins such that personnel are protected.

Another feature of the present application additionally and/or alternatively provides wherein personnel protections are governed by applicable regulations and/or standards.

Another feature of the present application additionally and/or alternatively provides wherein the wall is offset from conductive ends of the plurality of pins when the power connector is in an initial insert position.

Another feature of the present application additionally and/or alternatively provides wherein each of the plurality of pins includes an insulated cover over the tips of each of the respective pins.

Another feature of the present application additionally and/or alternatively provides wherein the covers protrude at least partially into each of the respective plurality of through passages when the power connector is not located within the power receptacle.

Still another aspect of the present application provides a method comprising: engaging a door of a power receptacle with a power connector; opening the power receptacle by engagement of the power connector with the door; seating the power connector within the power receptacle; as a result of the seating, disengaging a safety interlock to permit sliding motion of the power connector; translating the power connector while it is in the power receptacle to engage at least one pin electrically connected to a battery.

A feature of the present application provides wherein the disengaging includes coupling a disengagement structure of the power connector with a safety interlock of the power receptacle.

Another feature of the present application additionally and/or alternatively provides wherein the disengagement structure is a protrusion, and wherein the coupling includes insertion of the protrusion into a seating member of the power receptacle.

Another feature of the present application additionally and/or alternatively provides wherein the disengagement structure includes a plurality of disengagement structures.

Another feature of the present application additionally and/or alternatively provides wherein the plurality of disengagement structures include at least one disengagement structure that is longer than another of the plurality of disengagement structures.

Another feature of the present application additionally and/or alternatively further includes moving the power connector to a locked position in which the power connector is discouraged from removal from the power receptacle and in which the power connector is not engaged to any of the at least one pin.

Another feature of the present application additionally and/or alternatively further includes moving a cover in response to the translating the power connector

Another feature of the present application additionally and/or alternatively provides wherein the cover can be moved without disengagement of the safety interlock.

Another feature of the present application additionally and/or alternatively provides wherein the cover can be moved only if the safety interlock is disengaged.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An apparatus comprising:
a vehicle power inlet structured to mate a power connector to a vehicle, the vehicle power inlet having:
a power receptacle seat structured to receive the power connector, the power receptacle seat having a wall with a plurality of through passages structured to permit passage of a plurality of pins in electrical communication with an electric battery of the vehicle when the wall is moved relative to the plurality of pins;
a motive member structured to convey the power connector toward the plurality of pins when the power connector is inserted into the power receptacle seat such that relative movement occurs between the plurality of pins and the wall; and
wherein a safety interlock is engaged to permit relative movement of the wall with the plurality of pins via action of the motive member when the power connector is seated into an engagement position within the power receptacle

2. The apparatus of claim 1, wherein the engagement position is one in which the power connector is in communication with the power receptacle, which further includes a disengagement position in which the power connector is not in communication with the power receptacle, wherein the engagement position is one in which the power connector mechanically communicates with the safety interlock associated with the power receptacle, and wherein the power connector disengages the safety interlock when in the engagement position, the safety interlock discouraging relative movement of the plurality of pins to the wall when the safety interlock is engaged, and wherein the safety interlock permits relative movement of the plurality of pins to the wall when the safety interlock is disengaged.

3. The apparatus of claim 1, wherein the power receptacle is defined by a carriage, wherein the engagement position is defined by mechanical coupling of the power connector with a back wall of the carriage.

4. The apparatus of claim 3, wherein the power connector includes at least one protrusion that mechanically couples with a safety interlock associated with the power receptacle.

5. The apparatus of claim 4, wherein the power connector includes at least two protrusions, a first of which has a first length, a second of which has a second length, and wherein the first length is longer than the second length, the at least two protrusions structured to couple with the safety interlock, and wherein the carriage includes the wall.

6. The apparatus of claim 1, which further includes a cover that is displaced with movement of the wall, wherein the cover is decoupled from wall and can be moved without movement of the wall relative to the plurality of pins, and wherein the cover includes a periphery that encloses each of the plurality of pins.

7. The apparatus of claim 1, which further includes a vehicle having the vehicle power inlet, wherein the vehicle is a commercial vehicle, wherein the power inlet is structured to facilitate power transfers between a battery electrically connected to the plurality of pins and the power connector, the power inlet structured to facilitate transfer of power levels that require actuated connections between the power connector and the vehicle power inlet.

8. The apparatus of claim 7, wherein the motive member is in the form of an actuator is required to move the power connector from a locked position to a contact position, and wherein the actuator is actuated from a location removed from the plurality of pins such that personnel are protected in event of an arcing fault, and which further includes a door positioned to cover the power receptacle seat and structured to be displaced when a power connector is inserted into the power receptacle seat, the door having a closed position to enclose the power receptacle seat and an open position to permit insertion of the power connector into the power receptacle seat.

9. An apparatus comprising:
an electric vehicle having a power inlet structured to receive a power connector, the power inlet including a carriage having a power receptacle enclosed by a moveable door having an open and a closed position, the carriage also including a wall with at least one opening to permit passage of at least one electrical pin when the wall is moved relative to the at least one electrical pin, the power connector structured to move with the wall such that the power connector makes electrical contact with the at least one electrical pin when the wall moves to an engaged position, the carriage and wall being interlocked such that the carriage and wall are discouraged from movement and thus the power connector is discouraged from making electrical contact with the at least one electrical pin unless the power connector engages a safety interlock disengagement associated with the carriage.

10. The apparatus of claim 9, which further includes a motive member structured to displace the carriage when the power connector is seated in a power receptacle of the power inlet, and wherein the power connector includes a plurality of recesses structured to respectively receive the plurality of pins.

11. The apparatus of claim 10, wherein the motive member is an actuator, and wherein the safety interlock also includes an electrical interlock with the actuator such that the actuator is incapable of moving the power connector toward the plurality of pins when the safety interlock is engaged.

12. The apparatus of claim 9, which further includes a cover over the at least one electrical pin, and wherein the cover is released from a locked state when the power connector is in the engagement position within the power receptacle to disengage the safety interlock, and wherein the interlock includes a pin and ball assembly structured to prevent movement of the carriage when the power connector is not in a seated position sufficient to disengage the safety interlock.

13. The apparatus of claim 12, wherein the carriage closes off an opening through which the power connector was inserted into the power receptacle when the power connector is moved into contact with the pins of the battery, wherein the at least one electrical pin includes a non-conductive tip which is sized to operate as a sleeve cleaner, wherein the power connector includes at least one passage structured to receive the at least one pin, and wherein the con-conductive tip is sized to dislodge debris from the passage when the at least one pin is urged into contact by relative movement with the power connector.

14. The apparatus of claim 12, wherein the carriage moves in a horizontal direction, wherein the door is hingedly connected to the carriage, and which further includes a divider that shields a passage structured to receive the at least one electrical pin within the power receptacle when the power connector is in a disengagement position with the power receptacle, and wherein the divider is removed from the passage when the power connector is in the disengagement position.

15. The apparatus of claim 9, wherein the power connector includes a first position in the power receptacle corresponding to a seated position characterized in which the power connector is not in electrical contact with the plurality of pins, a second position in the power receptacle corresponding to a locked position characterized in which the power connector is not in electrical contact with the plurality of pins and in which the power connector is discouraged from removal from the power receptacle, and a third position in the power receptacle corresponding to a contact position characterized in which the power connector is in electrical contact with the plurality of pins, and which further includes a motive member structured to displace the carriage when the power connector is seated in the power receptacle of the power inlet, the motive member in the form of a manually operated lever.

16. A method comprising:
engaging a door of a power receptacle with a power connector;
opening the power receptacle by engagement of the power connector with the door;
seating the power connector within the power receptacle;
as a result of the seating, disengaging a safety interlock to permit sliding motion of the power connector;
translating the power connector while it is in the power receptacle to engage at least one electrically conductive pin.

17. The method of claim 16, wherein the disengaging includes coupling a disengagement structure of the power connector with a safety interlock of the power receptacle, wherein the disengagement structure is a protrusion, and wherein the coupling includes insertion of the protrusion into a seating member of the power receptacle.

18. The method of claim 17, which further includes moving the power connector to a locked position in which the power connector is discouraged from removal from the power receptacle and in which the power connector is not engaged to any of the at least one pin.

19. The method of claim 16, which further includes controlling an actuator to provide the translating, and which further includes moving a cover in response to the translating the power connector.

20. The method of claim 19, wherein the cover cannot be moved without disengagement of the safety interlock, and wherein the at least one electrically conductive pin is in electrical communication with a vehicle battery.
